(19) United States
(12) Patent Application Publication
(10) Pub. No.: US 2007/0014464 A1
(43) Pub. Date: Jan. 18, 2007

(54) OPTICAL COHERENCE TOMOGRAPH

(75) Inventor: Mitsuo Ohashi, Yokohama-shi, Kanagawa-ken (JP)

Correspondence Address: ROSSI, KIMMS & McDOWELL LLP., P.O. BOX 826, ASHBURN, VA, 20146-0826, US

(73) Assignee: Spectratech Inc., Tokyo-to (JP)

(21) Appl. No.: 11/383,591

(22) Filed: May 16, 2006

(30) Foreign Application Priority Data
May 17, 2005 (JP) 2005-143882

(51) Int. Cl. H05G 1/60; G06K 9/00; G01T 1/166

(52) U.S. Cl. 382/131; 250/363.04; 378/21

(57) ABSTRACT

A light emission section includes a plurality of light sources and emits near infrared low coherent light beams having different specific wavelengths to a light interference section. The light interference section allows the near infrared low coherent light beams to pass therethrough toward the eyeground and partially reflects the beams toward a movable mirror. Measurement light reflected by the eyeground and reference light reflected by the movable mirror interfere at the light interference section. Resultant interference light rays propagate to a light detection section, which calculates the profile of the eyeground from the light quantities of the interference light rays, and calculates the oxygen saturation SO₂ from the light quantity distributions of the near infrared low coherent light beams emitted from the light emission section and the light quantities of the received interference light rays. A display section displays the calculated profile and oxygen saturation SO₂ in a superposed manner.

### BACKGROUND OF THE INVENTION

1. Field of the Invention

The present invention relates to an optical coherence tomograph which measures and displays the profile (cross sectional shape) of an object to be examined within a living organism.

2. Background Art

In the medical field, use of optical coherence tomography has recently attracted attention, as it facilitates non-invasive measurement of the interior of a living organism. In optical coherence tomography, use of near infrared low coherence light attains micron-order imaging of neighboring regions. Optical coherence tomography has been put into practice particularly in the fields of intracatheters and endoscopes, and Japanese Patent Application Laid-Open (kokai) No. 2001-125009 discloses an endoscope which makes use of Michelson interferometry. This endoscope enables a physician to view the surfaces of the body cavity wall of a patient by use of visible light or excitation light and to observe the interior of an affected part on the basis of a tomogram obtained by optical coherence tomography using near infrared low coherence light, to thereby perform thorough examination. Therefore, cancer, tumor, or other pathological condition can be detected at an early stage, accurate diagnosis can be made quickly, and stress experienced by patients can be mitigated. Meanwhile, since optical coherence tomography achieves accurate and quick diagnosis and reduces stress imposed on patients, studies for application of this technique to eye diseases have been actively performed.

### SUMMARY OF THE INVENTION

Incidentally, although the endoscope disclosed in the above-mentioned publication enables a physician to obtain a tomogram of an affected part, the information the physician can obtain is limited to only that regarding the profile obtained from the tomogram. Therefore, in diagnosis of a patient in terms of pathological condition and development, the physician must rely on his/her experience and knowledge, which means increased burden imposed on the physician. In diagnosis of eye diseases, particularly an eye disease in the vicinity of the retina of the eyeball, observation of a very small area is required, thereby further increasing the burden imposed on the eye doctor. Moreover, in an eye disease involving necrosis of photoreceptor cells, such as glaucoma, accurate diagnosis may be difficult to perform on the basis of only the information regarding the profile obtained from a tomogram. Therefore, particularly in diagnosis of eye diseases, there has been keen demand for a practical optical coherence tomograph; i.e., a measuring apparatus which makes use of optical coherence tomography and which can provide eye doctors with a greater deal of accurate information.

The present invention has been accomplished to solve the aforementioned problems. An object of the present invention is to provide an optical coherence tomograph which enables users to observe the internal conditions of a living organism in non-invasively and in detail by use of biological information associated with the metabolism of the living organism.

The present invention provides an optical coherence tomograph comprising a controller operable by a user and outputting various signals on the basis of instructions from the user; a light emission section including a plurality of light sources emitting light on the basis of predetermined drive signals supplied from the controller and adapted to emit near infrared low coherent light beams having different specific wavelengths; a light interference section including separation means for allowing the near infrared low coherent light beams emitted from the light emission section to pass therethrough toward an object to be examined and for partially reflecting and separating the near infrared low coherent light beams, reflection means for reflecting the separated near infrared low coherent light beams toward the separation means, moving means for moving the reflection means along the optical axis of the near infrared low coherent light beams separated by means of reflection, and interfering means provided integrally with the separation means and adapted to cause optical interference between the near infrared low coherent light beams reflected by the reflection means and the near infrared low coherent light beams reflected by the object to be examined; a light detection section including light-receiving means for receiving interference light rays produced as a result of the optical interference at the light interference section, profile information calculation means for calculating profile information representing the profile of the object on the basis of the light quantities of the interference light rays received by the light-receiving means, biological information calculation means for calculating biological information of the object associated with metabolism of living organism on the basis of the light quantities of the near infrared low coherent light beams emitted from the light emission section and the light quantities of the interference light rays received by the light-receiving means, and image data generation means for generating visible image data on the basis of the profile information calculated by the profile information calculation means and the biological information calculated by the biological information calculation means; and a display section for displaying, on the basis of the image data generated by the light detection section, a profile image of the object, a biological information image of the object, or a composite image obtained through composition of the profile image and the biological information image. In this case, preferably, the display section displays a composite image obtained by mixing the profile image and the biological information image such that a position specified by the profile image of the object and a position specified by the biological information image of the object coincide with each other. Further, in this case, the biological information calculated by the biological information calculation means of the light detection section may be one selected from the group consisting of blood volume, blood flow rate, change in blood flow, and the degree of oxygen saturation (hereinafter simply referred to as “oxygen saturation”) within a blood vessel of the object. Moreover, the object may be the eyeground of the eyeball.

The optical coherence tomograph according to the present invention operates as follows. That is, when a user operates the controller, the light sources of the light emission section emit near infrared low coherent light beams having different specific wavelengths. The light interference section optically divides the near infrared low coherent light beams emitted from the light emission section to those toward an object to be examined (e.g., the eyeground of the eyeball) and those toward the reflection means, and causes optical interference between the near infrared low coherent light beams reflected at the object and the near infrared low coherent light beams reflected at the reflection means. Since the reflection means can be moved by the moving means, a measured portion of the object can be continuously changed by moving the reflection means. This enables optical interference between the near infrared low coherent light beams reflected at the reflection means and the near infrared low coherent light beams reflected at the measured portion of the object which is continuously changed in the direction along which the object is sectioned (hereinafter referred to as the “profile direction”).

The light detection section receives interference light rays, calculates profile information representing the profile of the object on the basis of the light quantities of the received interference light rays, and calculates biological information of the object, such as blood volume, blood flow rate, change in blood flow, and oxygen saturation on the basis of the light quantities of the near infrared low coherent light beams emitted from the light emission section and the light quantities of the received interference light rays. Further, the light detection section generates visible image data on the basis of the calculated profile information and the calculated biological information. The display section displays a profile image based on the calculated profile information, a biological information image based on the calculated biological information, or a composite image obtained through composition of the profile image and the biological information image. At this time, the display section can display a composite image obtained by mixing the profile image and the biological information image such that a position specified by the profile image of the object and a position specified by the biological information image of the object coincide with each other.

Accordingly, the optical coherence tomograph according to the present invention can calculate the profile and biological information of an object to be examined, and can display the calculated profile and biological information at the display section. Accordingly, a greater amount of accurate information can be provided to a medical doctor. In particular, when a medical doctor observes a region by use of a displayed image representing the profile, an image representing the biological information of a region corresponding to the region can be displayed while mixing (superimposing) the biological information image with the profile image. By virtue of this, a medical doctor can diagnose pathological condition and development considerably easily and accurately. Moreover, since blood volume, blood flow rate, change in blood flow, oxygen saturation, etc. can be easily calculated and displayed as biological information necessary for diagnosis of pathology, pathological condition and development can be diagnosed considerably easily and accurately. In addition, since the light emission section includes a plurality of light sources and can emit near infrared low coherent light beams having different specific wavelengths, for calculation of biological information, the light emission section can select and emit a near infrared low coherent light beam having a suitable wavelength. This enables more accurate calculation of biological information, and assists a medical doctor's diagnosis more properly.

According to another feature of the present invention, the light emission section further includes spread spectrum modulation means for modulating predetermined primary drive signals supplied from the controller by spread spectrum modulation to thereby generate secondary drive signals, and light-mixing means for optically mixing the near infrared low coherent light beams having different specific wavelengths simultaneously emitted from the light sources driven simultaneously on the basis of the secondary drive signals; and the light detection section further includes demodulation means for despreading and demodulating the secondary drive signals contained in the interference light rays received by the light-receiving means to thereby obtain the predetermined primary drive signals. Alternatively, the light emission section further includes frequency-division-multiple-access-modulation means for modulating predetermined primary drive signals supplied from the controller by means of frequency division multiple-access modulation to thereby generate secondary drive signals, and light-mixing means for optically mixing the near infrared low coherent light beams having different specific wavelengths simultaneously emitted from the light sources driven simultaneously on the basis of the secondary drive signals; and the light detection section further includes demodulation means for demodulating the secondary drive signals contained in the interference light rays received by the light-receiving means to thereby obtain the predetermined primary drive signals.

By virtue of these configurations, the plurality of light sources can emit light at one time (simultaneously) on the basis of the modulated secondary drive signals. The light-mixing means (e.g., an optical fiber) can optically mix the simultaneously emitted near infrared low coherent light beams having different specific wavelengths, and output a resulting light beam to the light interference section. The interference light produced as a result of optical interference at the light interference section is demodulated at the light detection section, whereby profile information and biological information are calculated.

In the case where a plurality of near infrared low coherent light beams having different specific wavelengths are emitted simultaneously, and their interference light is detected as described above, the biological information can be obtained, while change in conditions with elapse of time is minimized. That is, for example, oxygen concentration within the artery or arteriole is calculated, the oxygen concentration must be calculated on the basis of the quantity of interference light stemming from a pulse wave of the blood flow. At this time, since the state of the pulse wave changes at extremely high speed, in the case where near infrared low coherent light beams are successively emitted, the quantities of interference light rays detected by the light detection section for the near infrared low coherent light beams represent different states of the pulse wave. Therefore, the calculated biological information may be of poor accuracy. In contrast, in the case where near infrared low coherent light beams are simultaneously emitted, the quantities of interference light rays detected by the light detection section represent substantially the same state of the pulse wave. Therefore, the biological information can be calculated accurately, and a medical doctor's diagnosis can be assisted more properly.

According to another feature of the present invention, the light emission section acquires predetermined drive signals supplied from the controller with a predetermined time interval therebetween, and the light sources are successively driven on the basis of the acquired predetermined drive signals so as to successively emit near infrared low coherent light beams having different specific wavelengths with the predetermined time interval therebetween. In this case, preferably, the light emission section further includes spread spectrum modulation means for modulating, by spread spectrum modulation, predetermined drive signals supplied from the controller with the predetermined time interval therebetween to thereby generate modulated drive signals, whereby the light sources are successively driven by the modulated drive signals so as to successively emit near infrared low coherent light beams having different specific wavelengths with the predetermined time interval therebetween; and the light detection section further includes demodulation means for demodulating the modulated drive signals contained in the interference light rays received by the light receiving means to thereby obtain the predetermined drive signals. Alternatively, the light emission section further includes modulation means for modulating, by means of frequency division multiple-access modulation, predetermined drive signals supplied from the controller with the predetermined time interval therebetween to thereby generate modulated drive signals, whereby the light sources are successively driven by the modulated drive signals so as to successively emit near infrared low coherent light beams having different specific wavelengths with the predetermined time interval therebetween; and the light detection section further includes demodulation means for demodulating the modulated drive signals contained in the interference light rays received by the light receiving means to thereby obtain the predetermined drive signals.

By virtue of these configurations, near infrared low coherent light beams having different specific wavelengths can be successively emitted with a predetermined time interval therebetween. Thus, the detection speed required for the light-receiving means (e.g., photo detector) of the light detection section can be decreased, so that the production cost of the optical coherence tomograph can be lowered.

Moreover, another feature of the present invention resides in that a light separation section for optically separating interference light rays produced as a result of optical interference at the light interference section is provided between the light interference section and the light detection section, and the light detection section includes a plurality of right-receiving means for receiving the interference light rays separated by the light separation section. By virtue of this configuration, even when near infrared low coherent light beams having different specific wavelengths are simultaneously emitted from the light emission section, resultant interference light rays can be optically separated by the light separation section (e.g., a dichroic mirror or a half mirror). Therefore, the structure of the optical coherence tomograph can be simplified.

### BRIEF DESCRIPTION OF THE DRAWINGS

Various other objects, features, and many of the attendant advantages of the present invention will be readily appreciated as the same becomes better understood with reference to the following detailed description of the preferred embodiments when considered in connection with the accompanying drawings, in which:

FIG. 1 is a block diagram schematically showing a optical coherence tomograph according to first and second embodiments of the present invention;

FIG. 2 is a block diagram schematically showing the configuration of a light emission section shown in FIG. 1;

FIG. 3 is a block diagram schematically showing the configuration of a light interference section shown in FIG. 1;

FIG. 4 is a block diagram schematically showing the configuration of a light detection section shown in FIG. 1;

FIG. 5 is a schematic illustration used for describing a method of obtaining the degree of oxygen saturation;

FIG. 6 is a graph schematically showing change in the molecular light absorption coefficient of oxy-hemoglobin or deoxy-hemoglobin with respect to wavelength;

FIG. 7 is a block diagram schematically showing the configuration of an image processing unit shown in FIG. 4;

FIG. 8 is a block diagram schematically showing the configuration of a display section shown in FIG. 1;

FIG. 9 is a block diagram schematically showing the configuration of a light emission section according to a second embodiment of the present invention;

FIG. 10 is a block diagram schematically showing the configuration of a light detection section according to the second embodiment;

FIG. 11 is a graph schematically showing change in molecular light absorption coefficient with respect to wavelength for different degrees of oxygen saturation; and

FIG. 12 is a block diagram schematically showing an optical coherence tomograph according to a modified embodiment of the present invention.

### DETAILED DESCRIPTION OF PREFERRED EMBODIMENTS

### a. First Embodiment

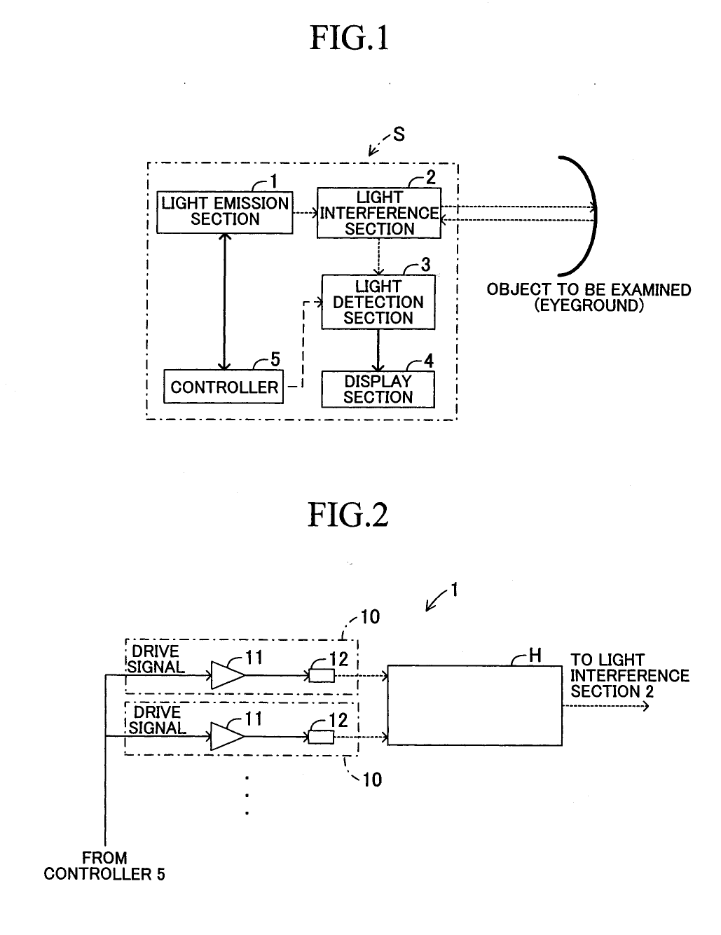

A first embodiment of the present invention will next be described with reference to the drawings. FIG. 1 schematically shows the configuration of an optical coherence tomograph S according to the present embodiment adapted to measure the shape of an interior part of a living organism; e.g., the shape of the eyeground. As shown in FIG. 1, the optical coherence tomograph S includes a light emission section 1, a light interference section 2, a light detection section 3, and a display section 4. The optical coherence tomograph S also includes a controller 5, which is mainly composed of a microcomputer including a CPU, ROM, RAM, etc.

As shown in FIG. 2, the light emission section 1 is composed of a plurality of light generation units 10 which generate light beams having different specific wavelengths. In the present embodiment, the light emission section 1 is composed of two light generation units 10; that is, the light emission section 1 generates light beams having two specific wavelengths. However, no restriction is imposed on the number of the light generation units 10 of the light emission section 1; i.e., the number of specific wavelengths of outgoing light. For example, the light emission section 1 may be configured to include three or more light generation units 10. Through provision of a large number of light generation units 10, quantitative calculation of the degree of oxygen saturation (biological information) to be described later can be performed sufficiently.

Each light generation unit 10 includes a light source driver 11 for acquiring or obtaining a drive signal supplied from the controller 5. On the basis of the drive signal obtained from the controller 5, the light source driver 11 drives a light source 12. The light source 12 is composed of a near infrared light emitting element such as a super luminescent diode (SLD). Thus, the light source 12 emits near infrared low coherent light having a specific wavelength. The specific wavelength of the near infrared low coherent light emitted by the light source 12 is preferably determined to fall within a range of 600 nm to 900 nm, for example. The following description is based on the assumption that one light source 12 emits near infrared low coherent light having a specific wavelength of 830 nm, and the other light source 12 emits near infrared low coherent light having a specific wavelength of 780 nm. The near infrared low coherent light emitted by each light source 12 is caused to propagate to the light interference section 2 by means of, for example, an optical fiber H, serving as light mixing means.

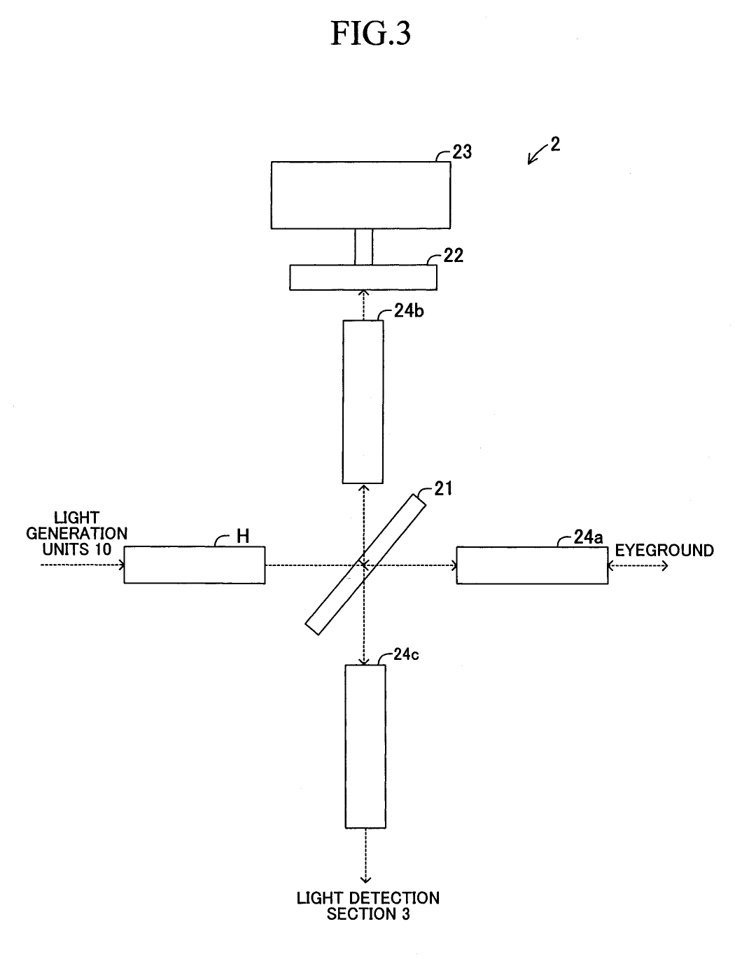

The light interference section 2 divides the near infrared low coherent light emitted from the light emission section 1 into two light beams propagating in two directions, and causes interference between corresponding reflection light beams of the two near infrared low coherent light beams. For such a purpose, as shown in FIG. 3, the light interference section 2 includes a beam splitter 21, a movable mirror 22, a mirror moving mechanism section 23, and optical fibers 24a to 24c. The beam splitter 21 is disposed to incline at an angle of, for example, 45 degrees in relation to the optical axis of the near infrared low coherent light beam output by means of the light generation units 10 via the optical fiber H. The beam splitter 21 permits the near infrared low coherent light beam output from the light emission section 1 to pass toward the eyeground, and reflects the light beam toward the movable mirror 22. The near infrared low coherent light beam having passed through the beam splitter 21 propagates toward the eyeground via the optical fiber 24a, which is disposed such that its optical axis coincides with that of the optical fiber H of the light emission section 1. The near infrared low coherent light beam reflected by the beam splitter 21 propagates toward the movable mirror 22 via the optical fiber 24b.

The movable mirror 22 is disposed in such a manner that its reflection surface perpendicularly intersects the optical axis of the near infrared low coherent light beam reflected by the beam splitter 21; i.e., the optical axis of the optical fiber 24b. The movable mirror 22 reflects toward the beam splitter 21 the near infrared low coherent light beam reflected by the beam splitter 21. The mirror moving mechanism section 23 moves the movable mirror 22 in a direction perpendicular to the reflection surface.

Operation of the light interference section 2 having the above-described configuration will now be described. Each of the near infrared low coherent light beams output from the light generation units 10 of the light emission section 1 propagates toward the beam splitter 21 via the optical fiber H. The near infrared low coherent light beam having reached the beam splitter 21 partially passes through the beam splitter 21, propagates through the optical fiber 24a, and reaches the eyeground. Although not illustrated, for example, a two-axis galvanometer mirror may be used to cause the near infrared low coherent light beam output from the optical fiber 24a to sweep along the lateral direction of the eyeground; i.e., an equi-optical path surface. A reflection light beam from the eyeground (hereinafter, this reflection light beam will be referred to as “measurement light”) is reflected by the beam splitter 21 and supplied to the light detection section 3.

Meanwhile, each of the near infrared low coherent light beams output from the light generation units 10 of the light emission section 1 is partially reflected by the beam splitter 21, and reaches the movable mirror 22. The near infrared low coherent light beam reflected by the movable mirror 22 (hereinafter, this reflected near infrared low coherent light beam will be referred to as “reference light”) passes through the beam splitter 21, and reaches the light detection section 3. The measurement light and the reference light interfere with each other at the beam splitter 21, and resultant interference light is output via the optical fiber 24c, disposed to coincide with the optical axis of the optical fiber 24b, and is detected by means of the light detection section 3. A widely known method for causing two light beams to interfere with each other is Michelson interferometry.

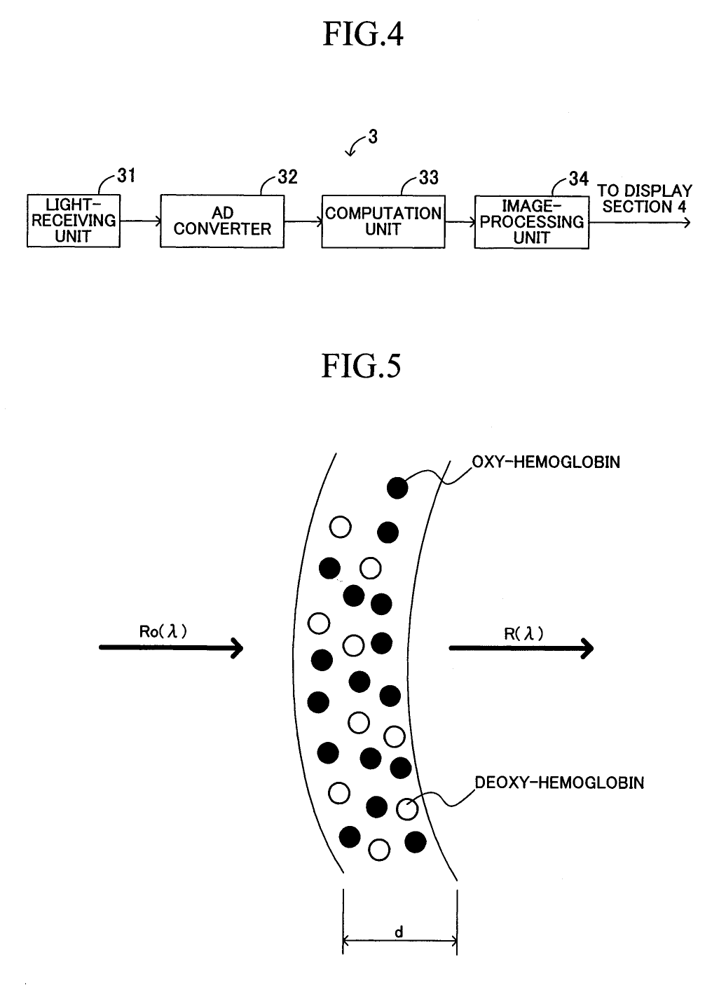

The light detection section 3 detects near infrared low coherent light which is produced as a result of interference between the reference light and the measurement light and output from the light interference section 2 (hereinafter also referred to as “interference light”), and outputs an image signal representing the state of the eyeground on the basis of a detection signal corresponding to the detected interference light. For such a purpose, as shown in FIG. 4, the light detection section 3 includes a light-receiving unit 31, an AD converter 32, a computation unit 33, and an image-processing unit 34. The light-receiving unit 31 is mainly composed of a photo detector or a photo diode. Upon receipt of interference light from the light interference section 2, the light-receiving unit 31 outputs an electrical detection signal to the AD converter 32 in a time series fashion. The AD converter 32 converts the electrical detection signal (analog signal) output from the light-receiving unit 31 to a digital signal, and outputs the digital signal to the computation unit 33.

On the basis of the detection signal output from the AD converter 32, the computation unit 33 calculates a profile signal representing a profile (cross section), through use of the light quantity distribution of the interference light; i.e., the measurement light reflected from the eyeground and having interfered with the reference light. The calculation of the profile signal will be described specifically later. Further, the computation unit 33 calculates the oxygen saturation SO₂ of the blood flowing through the capillary at the eyeground by use of the quantity of light output from the light emission section 1 and the quantity of the received interference light. Next, the calculation of the blood oxygen saturation SO₂ by the computation unit 33 will be described. The absorption of near infrared light by hemoglobin in the blood; specifically, by hemoglobin bound to oxygen (hereinafter referred to as “oxy-hemoglobin”) and hemoglobin not bound to oxygen (hereinafter referred to as “deoxy-hemoglobin”) can be represented by the following Eq. 1 in accordance with the Lambert-Beer law, as is generally known and described in literature (e.g., Hitachi Medical Corp., MEDIX, vol. 29).
−ln(R(λ)/Ro(λ))=εoxy(λ)·Coxy·d+εdeoxy(λ)·Cdeoxy·d+α(λ)+S(λ) Eq. 1

As schematically shown in FIG. 5, R(λ), Ro(λ), and d in Eq. 1 represent the quantity of detected light of wavelength λ, the quantity of output light of wavelength λ, and the optical path length of the detected region, respectively. Further, εoxy(λ) represents the molecular light absorption coefficient of oxy-hemoglobin for the wavelength λ, and εdeoxy(λ) represents the molecular light absorption coefficient of deoxy-hemoglobin for the wavelength λ. Further, Coxy represents the concentration of oxy-hemoglobin, and Cdeoxy represents the concentration of deoxy-hemoglobin. Moreover, α(λ) represents attenuation through absorption of light by pigments within the blood other than hemoglobin (e.g., cytochrome aa33 reflecting the demand and supply of oxygen at mitochondria in cells), and S(λ) represents attenuation through scattering of light at the tissue of the living organism.

On the basis of the light absorption characteristics of hemoglobin in the blood represented by Eq. 1, the blood oxygen saturation SO₂ can be calculated in consideration of a difference between the characteristics before and after the blood flow within the blood vessel changes. Specifically, when the light absorption characteristics before a change in the blood flow are represented in accordance with Eq. 1 for a capillary present at the eyeground, the light absorption characteristics after the change in the blood flow can be represented by the following Eq. 2.
−ln(growthR(λ)/Ro(λ))=εoxy(λ)·growthCoxy·d+εdeoxy(λ)·growthCdeoxy·d+growthα(λ)+S(λ) Eq. 2
Notably, growthR(λ), growthCoxy, growthCdeoxy, and growthα(λ) in Eq. 2 represent respective values which have increased or decreased as a result of the blood flow change; i.e., represent the quantity of detected light after the blood flow change, the concentration of oxy-hemoglobin after the blood flow change, the concentration of deoxy-hemoglobin after the blood flow change, and the attenuation after the blood flow change through absorption of light by pigments within the blood other than hemoglobin.

Since the quantity of light absorbed by hemoglobin within the blood is considerably large as compared with the quantity of light absorbed by pigments other than hemoglobin, α(λ) in Eq. 1 can be replaced with growthα(λ). Thus, the following Eq. 3 can be obtained by subtracting Eq. 1 from Eq. 2.
−ln(growthR(λ)/R(λ))=εoxy(λ)·ΔCoxy+εdeoxy(λ)·ΔCdeoxy Eq. 3
Here, ΔCoxy and ΔCdeoxy in Eq. 3 are represented by the following Eqs. 4 and 5, respectively.
ΔCoxy=(growthCoxy−Coxy)·d Eq. 4
ΔCdeoxy=(growthCdeoxy−Cdeoxy)·d Eq. 5

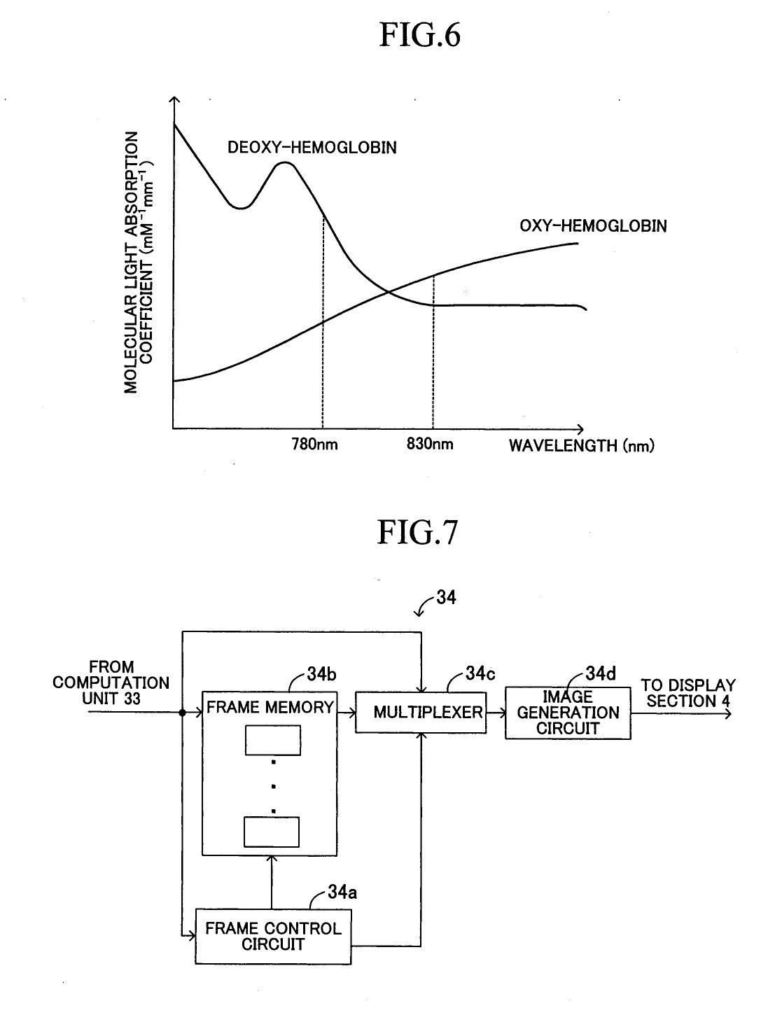

FIG. 6 schematically shows the light absorption spectrum of hemoglobin. As shown in FIG. 6, a specific wavelength at which the oxy-hemoglobin and the deoxy-hemoglobin exhibit different light absorption characteristics to thereby provide a high contrast ratio; e.g., a wavelength (α) of 780 nm or 830 nm is selected for measurement by use of near infrared low coherent light. By solving Eq. 3 on the basis of results of the measurement, the oxy-hemoglobin concentration change ΔCoxy, the deoxy-hemoglobin concentration change ΔCdeoxy, and the total hemoglobin concentration change (ΔCoxy+ΔCdeoxy) can be calculated in a relative manner. Through calculation of these values, the relative oxygen saturation SO₂ represented by the following Eq. 6 can be obtained.
SO₂=ΔCoxy/(ΔCoxy+ΔCdeoxy) Eq. 6
As described above, after calculation of the profile of the eyeground and the oxygen saturation SO₂, the computation unit 33 outputs to the image-processing unit 34 a profile signal representing the calculated profile and an oxygen saturation signal representing the calculated oxygen saturation SO₂.

The oxy-hemoglobin concentration change ΔCoxy, the deoxy-hemoglobin concentration change ΔCdeoxy, the total hemoglobin concentration change (ΔCoxy+ΔCdeoxy), and the oxygen saturation SO₂ are calculated by use of the detected light quantity of the measurement light (interference light); i.e., near infrared low coherent light having reached the interior of the eyeground and reflected by hemoglobin within capillaries. Whereas the detected light quantity of the measurement light (interference light) represents the reflection strength (change in refractive index, etc.) at a predetermined measurement depth, the measurement light (interference light) is influenced by the hemoglobin concentration over the entire optical path through which the near infrared low coherent light passes. That is, when the measurement depth from the surface of the eyeground is represented by D, the light quantity of the measurement light (interference light) is influenced by absorption which occurs two times; i.e., absorption in the forward propagation from the eyeground surface to the measurement depth D and the back propagation from the measurement depth D to the eyeground surface.

Accordingly, the oxy-hemoglobin concentration change ΔCoxy, the deoxy-hemoglobin concentration change ΔCdeoxy, the total hemoglobin concentration change (ΔCoxy+ΔCdeoxy), and the oxygen saturation SO₂ in consideration of absorption of the measurement light (interference light) inside the eyeground are preferably calculated through obtainment of the ratio between the quantity of the measurement light (interference light) at the predetermined measurement depth and the quantity of the measurement light (interference light) at a point deviated from the predetermined measurement depth by a change amount Δ. At this time, the light quantity ratio is preferably obtained for a pair of near infrared low coherent light beams of different wavelengths (e.g., 780 nm and 830 nm), which are substantially identical in terms of the reflection strength at the predetermined measurement depth and the reflection strength at the deviated point and which differ in terms of absorption attenuation by hemoglobin. When such a pair of near infrared low coherent light beams of different wavelengths are used, the refractive index, which determines the reflection strength, can be ignored within the substances which form the living organism, because of the small difference between the two wavelengths. Thus, the absorption attenuation ratio at the two wavelengths of the measurement light (interference light) within the width Δ can be obtained, whereby the respective hemoglobin concentrations can be calculated by use of the absorption attenuation ratio. Accordingly, the oxy-hemoglobin concentration change ΔCoxy, the deoxy-hemoglobin concentration change ΔCdeoxy, the total hemoglobin concentration change (ΔCoxy+ΔCdeoxy), and the oxygen saturation SO₂ only at the measurement depth can be calculated.

As shown in FIG. 7, the image-processing unit 34 includes a frame control circuit 34a, frame memories 34b, a multiplexer 34c, and an image generation circuit 34d. The frame control circuit 34a controls operations of the frame memories 34b and the multiplexer 34c. Under the control by the frame control circuit 34a, the frame memories 34b output to the image generation circuit 34d the profile signal or oxygen saturation signal output from the computation unit 33. The image generation circuit 34d generates image data on the basis of the output profile signal or oxygen saturation signal, and the image data are displayed on the display section 4 in a predetermined manner. In the present embodiment, the profile signal or oxygen saturation signal output from the computation unit 33 is temporarily stored in the frame memories 34b. However, if necessary, these signals may be output directly to the multiplexer 34c.

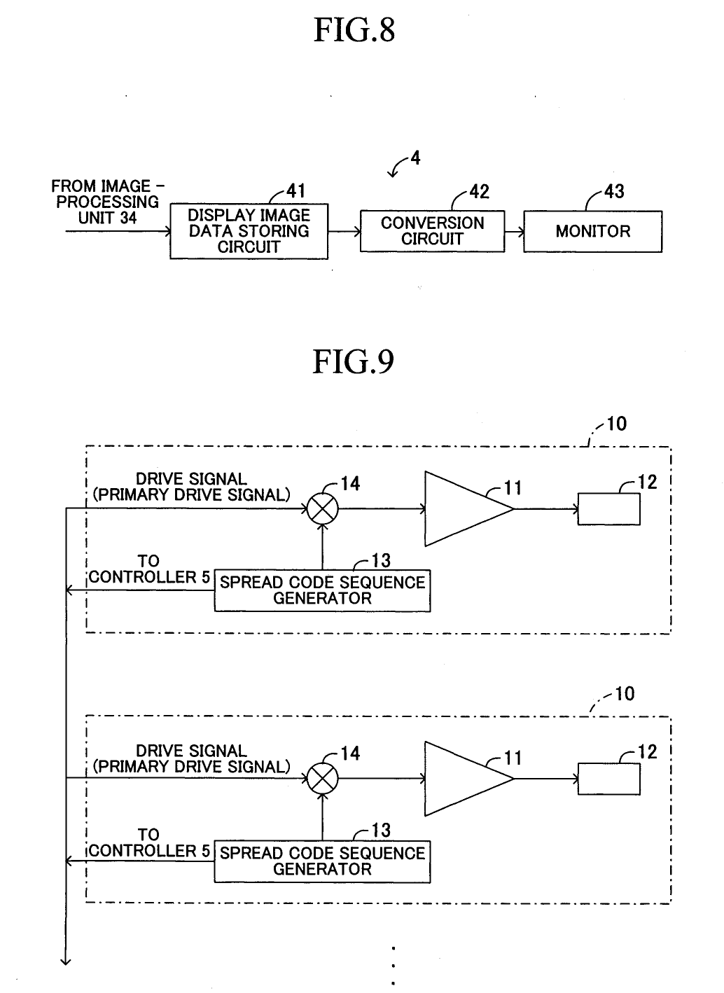

As shown in FIG. 8, the display section 4 includes a display image data storing circuit 41, a conversion circuit 42, and a monitor 43 such as a liquid crystal display. When necessary, before storing image data, the display image data storing circuit 41 mixes profile image data and oxygen saturation image data, and superposes additional data (information), such as numerals and various characters, on the profile image data, the oxygen saturation image data, and the mixed image data. The conversion circuit 42 performs, for example, D/A conversion and video format conversion for the image data stored in the display image data storing circuit 41. On the basis of the image data output from the image-processing unit 34 of the light detection section 3, the display section 4 displays the profile of the eyeground or the oxygen saturation as is, or after mixing (superposing) these image data.

Next, operation of the optical coherence tomograph S of the present embodiment having the above-described configuration will be described, by reference to an example case where the eyeground of a patient is observed.

A medical doctor or operator places the optical coherence tomograph S such that the eyeball of the patient is located on the optical axis of the near infrared low coherent light beam output from the light emission section 1. The medical doctor or operator then operates an unillustrated input unit of the controller 5 to thereby instruct start of output of the near infrared low coherent light beam. In response thereto, the controller 5 supplies, at predetermined, short intervals, to the two light generation units 10 of the light emission section 1 respective drive signals for driving the light generation units 10. Thus, the two light generation units 10 alternately start their operations at predetermined, short intervals.

That is, in the light generation unit 10 for emitting a near infrared low coherent light beam of 830 nm, the light source driver 11 receives the drive signal supplied from the controller 5 at predetermined, short intervals. As a result, on the basis of the received drive signal, the light source driver 11 causes the light source 12 to emit an optical pulse, whereby a near infrared low coherent light beam of 830 nm is output from the light source 12. Similarly, in the light generation unit 10 for emitting a near infrared low coherent light beam of 780 nm, the light source driver 11 receives the drive signal supplied from the controller 5 at predetermined, short intervals. As a result, on the basis of the received drive signal, the light source driver 11 causes the light source 12 to emit an optical pulse, whereby a near infrared low coherent light beam of 780 nm is output from the light source 12.

The near infrared low coherent light beam (pulse) output from the light emission section 1 is optically divided into two near infrared low coherent light beams by means of the beam splitter 21 of the light interfering section 2. One near infrared low coherent light beam (hereinafter referred to as the “first near infrared low coherent light beam”) propagates straight, and reaches the eyeball of the patient. The other near infrared low coherent light beam (hereinafter referred to as the “second near infrared low coherent light beam”) is reflected by the beam splitter 21, and reaches the movable mirror 22.

The first near infrared low coherent light beam having entered the eyeball is reflected at the eyeground, and reaches the beam splitter 21 as measurement light. Meanwhile, the second near infrared low coherent light beam having reached the movable mirror 22 is reflected by the movable mirror 22, and reaches the beam splitter 21 as reference light.

After having reached the beam splitter 21, the measurement light is reflected by the beam splitter 21, and propagates toward the light detection section 3, and the reference light passes straight through the beam splitter 21, and propagates toward the light detection section 3. If the distance L1 between the beam splitter 21 and the eyeground and the distance L2 between the beam splitter 21 and the movable mirror 22 are equal to each other, the measurement light and the reference light interfere at the beam splitter 21. Thus, the light detection section 3 detects interference light; i.e., near infrared low coherent light produced as a result of the interference. Meanwhile, if the distance L1 and the distance L2 differ from each other, the measurement light and the reference light do not interfere at the beam splitter 21. Thus, the measurement light and the reference light both attenuate, and the detection section 3 does not detect near infrared low coherent light.

In other words, when the distance L1 between the beam splitter 21 and the eyeground and the distance L2 between the beam splitter 21 and the movable mirror 22 are equal to each other, the measurement light reflected at the eyeground is well detected by the light detection section 3; and when the distance L1 and the distance L2 differ from each other, the measurement light is not detected by the light detection section 3. Therefore, in a state where a plurality of measurement light rays which differ in the distance L1 reach the light detection section 3 because of reflection at various locations such as the surface of the eyeground and the interior of the eyeground as viewed in the profile thereof, of these measurement light rays, only a measurement light ray whose distance is equal to the distance L2 is detected.

Since the movable mirror 22 can be moved along the optical axis of the reference light by means of the mirror moving mechanism section 23, the distance L2 can be changed freely. Therefore, the distance L1 of propagation of the measurement light which can be detected by the light detection section 3 can be changed gradually by operating the mirror moving mechanism section 23 to thereby change the distance L2. Accordingly, it becomes possible to successively change the specific region of the eyeground; i.e., the region to be measured, by gradually changing the distance L2, to thereby selectively detect the measurement light from the region to be measured.

In the light detection section 3, the light-receiving unit 31 receives the measurement light having interfered with the reference light at the beam splitter 21 as described above, and outputs an electrical detection signal corresponding to the received measurement light to the AD converter 32 in a time series fashion. Notably, the magnitude of the electrical detection signal is in proportion to the reflection strength (light quantity) at the eyeground. The duration of the electrical detection signal can be shortened by reducing the pulse width of the near infrared low coherent light beam generated by the light source 12, whereby the distance resolution of the measurement can be improved.

The AD converter 32 converts the output electrical detection signal to a digital signal, and outputs the digital signal to the computation unit 33. The computation unit 33 calculates a profile of the eyeground on the basis of the detection signal corresponding to the near infrared low coherent light beam of 830 nm output from the light emission section 1, and outputs a profile signal representing the calculated profile. Specifically, as described above, the movable mirror 22 can be moved along the optical axis of the reference light, through operation of the mirror moving mechanism section 23, so as to properly change the distance L2. Since the distance L1 is also changed as a result of the change in the distance L2, the region to be measured can be changed from the surface of the eyeground to the interior of the eyeground in the profile direction.

When the region to be measured is changed in the above-described manner, the measurement light which reaches the light-receiving unit 31 of the light detection section 3 is measurement light reflected by a reflection surface located at a certain point in the profile direction of the eyeground, and the detection signal supplied from the light-receiving unit 31 to the computation unit 33 via the AD converter 32 represents the two-dimensional quantity distribution of the measurement light at the reflection surface. Therefore, the computation unit 33 can obtain the quantity distribution of the measurement light at each of different reflection surfaces, by changing the distance L2 between the beam splitter 21 and the movable mirror 22; i.e., the distance L1 between the beam splitter 21 and the eyeground. The quantity distribution of the measurement light changes depending on the shape of each reflection surface. Therefore, the profile of the eyeground can be calculated through execution of composing calculation in which the quantity distributions are superimposed in the profile direction. The computation unit 33 then outputs to the image-processing unit 34 the profile signal representing the calculated profile of the eyeground.

Moreover, through use of the detection signal supplied from the AD converter 32 and corresponding to the near infrared low coherent light beam of 830 nm and the detection signal supplied from the AD converter 32 with a predetermined, short interval and corresponding to the near infrared low coherent light beam of 780 nm, the computation unit 33 calculates the oxygen saturation SO₂ of a region corresponding to the calculated profile of the eyeground, and outputs an oxygen saturation signal representing the calculated oxygen saturation SO₂. That is, the computation unit 33 calculates the oxygen saturation SO₂ in accordance with the above-described Eqs. 1 to 6 and through use of the obtained detected signals corresponding to the near infrared low coherent light beams of 830 nm and 780 nm; i.e., the light quantity distribution at a certain reflection surface as in the case of the above-described calculation of the profile of the eyeground. Accordingly, through execution of composing calculation in which the oxygen saturations SO₂ calculated for successively selected reflection surfaces are superimposed in the profile direction, the oxygen saturation SO₂ corresponding to each position of the profile of the eyeground can be calculated. The computation unit 33 then outputs to the image-processing unit 34 the oxygen saturation signal representing the calculated oxygen saturation SO₂.

In the image-processing unit 34, the frame control circuit 34a causes the frame memories 34b to temporarily store the profile signal and the oxygen saturation signal output from the computation unit 33. Subsequently, the frame control circuit 34a causes the multiplexer 34c to output to the image generation circuit 34d the profile signal and the oxygen saturation signal and temporarily stored at predetermined memory locations of the frame memories 34b. The image generation circuit 34d generates, on the basis of the output profile signal, profile image data representing the profile of the eyeground, and generates, on the basis of the output oxygen saturation signal, oxygen saturation image data representing the oxygen saturation SO₂ corresponding to each position of the profile of the eyeground. The image generation circuit 34d then outputs the generated profile image data and oxygen saturation image data to the display section 4.

In the display section 4, the display image data storing circuit 41 temporarily stores the profile image data and oxygen saturation image data supplied from the image generation circuit 34d. The conversion circuit 42 converts the image data stored in the display image data storing circuit 41 to display data, and the monitor 43 displays the profile of the eyeground and the oxygen saturation of the eyeground individually or in a composed or mixed manner.

As can be understood from the above description, the optical coherence tomograph S according to the present embodiment can measure the profile of the eyeground and the oxygen saturation SO₂ in a region corresponding to the profile of the eyeground. Thus, the measured profile and oxygen saturation SO₂ can be displayed in a composed or mixed manner. Therefore, when a medical doctor examines an eye disease, such as glaucoma, involving necrosis of photoreceptor cells, he/she can find the pathology in an early stage, because both the measured profile of the eyeground and the oxygen saturation SO₂ can be provided. That is, in the case of optical coherence tomographs and eyeground cameras conventionally used for examination of such a type, although the profile and surface shape of the eyeground can be observed in detail, the medical doctor must determine the progress of the eye disease, while relying on his/her experience and knowledge. However, since the optical coherence tomograph S according to the present embodiment enables simultaneous observation of the profile of the eyeground and the oxygen saturation SO₂, a drop in oxygen saturation SO₂ due to, for example, necrosis of photoreceptor cells, can be checked very easily. This preferably assists the medical doctor's diagnosis, and enables the medical doctor to take proper measures for the patient in an early stage.

In the first embodiment, the controller 5 supplies to the two light generation units 10 of the light emission section 1 drive signals for driving the light generation units 10 at predetermined, short intervals. However, the controller 5 may be configured to supply the drive signals such that the output intervals of near infrared low coherent light by the light generation units 10 become longer. Through an increase in the output intervals of near infrared low coherent light, for example, the light detection speed of the light-receiving unit 31 (photo detector, etc.) can be decreased, so that the production cost of the optical coherence tomograph S can be lowered.

### b. Second Embodiment

In the first embodiment, the controller 5 controls the light emission section 1 such that a predetermined, short interval is present between the light emission timings of the two light generation units 10, and the light generation units 10 emit near infrared low coherent light substantially simultaneously. The light emission timings can be made coincident with each other by means of spread-spectrum-modulation of the near infrared low coherent light output from the light generation units 10. Hereinafter, this second embodiment will be described, wherein portions identical with those of the first embodiment are denoted by the same reference numerals, and their detailed descriptions are not repeated.

The light emission section 1 of the optical coherence tomograph S of the second embodiment outputs near infrared low coherent light beams having specific wavelengths and having undergone spread-spectrum-modulation. Therefore, as shown in FIG. 9, each of the light generation units 10 of the second embodiment includes a spread code sequence generator 13 for generating a spread code sequence such as a 128-bit pseudorandom noise (PN) sequence which consists of “+1” and “−1.” The spread code sequence generator 13 generates, for example, a Hadamard sequence, an M sequence, or a Gold code sequence as a PN sequence.

The aforementioned Hadamard sequence, M sequence, and Gold code sequence are similar to those employed for spread spectrum modulation, and thus detailed description of their generation methods is omitted. However, these sequences will next be described briefly. The Hadamard sequence is obtained from each of the rows or columns of a Hadamard matrix which consists of “+1” and “−1.” The M sequence is a binary sequence obtained by use of a shift register consisting of n 1-bit register units, each memorizing “0” or “+1.” The shift register is configured such that the exclusive logical sum of the value of an intermediate register unit and the value of the final register unit is fed to the first register unit. Notably, in order to transform this binary sequence into a PN sequence, the value “0” is converted into “−1” through level conversion. The Gold code sequence is basically obtained through addition of two types of M sequences. Therefore, the Gold code sequence can increase the number of sequences considerably, as compared with the case of the M sequence. Among these sequences serving as PN sequences, two arbitrary sequences are orthogonal with each other, and the sum of products of the two sequences yields the value “0.” That is, one of these sequences has zero correlation with the other sequences.

The PN sequence generated by the spread code sequence generator 13 is output to the controller 5, and is also output to a multiplier 14. The multiplier 14 multiplies a drive signal (primary drive signal) supplied from the controller 5 by the PN sequence supplied from the spread code sequence generator 13. Thus, the drive signal (primary drive signal) can be subjected to spread spectrum modulation. The multiplier 14 supplies the thus-spread-spectrum-modulated drive signal (i.e., secondary drive signal) to a light source driver 11. The multiplier 14 serves as the spread spectrum modulation means of the apparatus of the present invention. The light source driver 11 of the second embodiment drives the light source 12 on the basis of the secondary drive signal supplied from the multiplier 14.

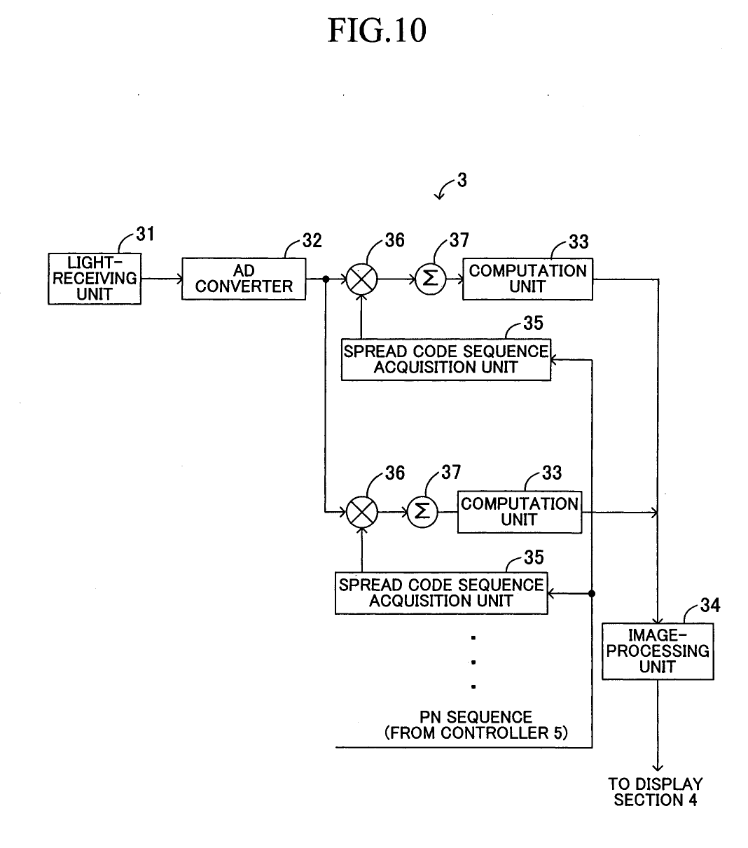

As shown in FIG. 10, the light detection section 3 of the second embodiment includes a plurality of spread code sequence acquisition units 35 for selectively receiving the measurement light (interfered with the reference light) derived from the near infrared low coherent light beam emitted from a specific light generation unit 10 of the light emission section 1. As indicated by a broken line in FIG. 1, each spread code sequence acquisition unit 35 is connected to the controller 5, and acquires, from the controller 5, the spread code sequence (i.e., PN sequence) contained in the near infrared low coherent light beam emitted from the corresponding specific light generation unit 10. The spread code sequence acquisition unit 35 supplies the thus-acquired PN sequence to a corresponding multiplier 36.

The multiplier 36 multiplies the detection signal output from the AD converter 32 by the PN sequence supplied from the spread code sequence acquisition unit 35. Subsequently, the multiplier 36 outputs the thus-calculated product of the detection signal and the PN sequence to an accumulator 37. The accumulator 37 accumulates the thus-supplied product over one or more periods of the above-supplied PN sequence. Subsequently, the accumulator 37 outputs, to the computation unit 33, a detection signal corresponding to the measurement light; i.e., near infrared low coherent light which has been emitted from the specific light generation unit 10 and reflected at the eyeground.

Next, operation of the optical coherence tomograph S of the second embodiment having the above-described configuration will be described, while observation of the eyeground of a patient is taken as an example as in the above-described first embodiment.

In the second embodiment as well, a medical doctor or operator places the optical coherence tomograph S such that the eyeball of the patient is located on the optical axis of the near infrared low coherent light beam output from the light emission section 1. The medical doctor or operator then operates the controller 5 to thereby instruct start of output of the near infrared low coherent light beam. In response thereto, the controller 5 supplies to the two light generation units 10 of the light emission section 1 respective primary drive signals for driving the light generation units 10. In response thereto, the two light generation units 10 simultaneously start their operations and output a near infrared low coherent light beam of 830 nm and a near infrared low coherent light beam of 780 nm, respectively.

That is, in each of the light generation units 10, the spread code sequence generator 13 generates, for example, a Gold code sequence as a PN sequence. Subsequently, the spread code sequence generator 13 outputs the thus-generated PN sequence to the controller 5, as well as to the multiplier 14. The multiplier 14 calculates the product of the PN sequence and the drive signal supplied from the controller 5 (i.e., primary drive signal), thereby subjecting the drive signal to spread spectrum modulation. When the thus-spread-spectrum-modulated drive signal (i.e., secondary drive signal) is supplied to the light source driver 11, the light source driver 11 causes the light source 12 to generate an optical pulse.

The two near infrared low coherent light beams output from the light emission section 1 are optically mixed by means of the optical fiber H. Subsequently, like the first embodiment, the resultant light beam is optically divided into two near infrared low coherent light beams by means of the beam splitter 21 of the light interfering section 2. The first near infrared low coherent light beam propagates straight and reaches the eyeball of the patient, and the second near infrared low coherent light beam reaches the movable mirror 22. The measurement light reflected at the eyeground and the reference light reflected by the movable mirror 22 interfere with each other and reach the light detection section 3.

Next, detection of the measurement light by the light detection section 3 will be described. The measurement light having interfered with the reference light at the beam splitter 21 is detected by the light-receiving unit 31 of the light detection section 3. At this time, a light ray having a wavelength of 830 nm and a light ray having a wavelength of 780 nm reach the light-receiving unit 31 as the measurement light. In this condition, the controller 5 controls the light detection section 3 to selectively detect, among the received measurement light rays, a measurement light ray which is based on the near infrared low coherent light beam emitted from the specific light generation unit 10. The control by the controller 5 will be described specifically.

After having supplied the primary drive signals to the light emission section 1 as described above, the controller 5 acquires PN sequences from the light generation units 10. Subsequently, the controller 5 supplies, to the light detection section 3, the PN sequences acquired from the spread code sequence generators 13 of the light generation units 10. Thus, the spread code sequence acquisition units 35 of the light detection section 3 acquire the supplied PN sequences, and supply the thus-acquired PN sequences to the multipliers 36.

The light-receiving unit 31 receives all the measurement light rays having interfered with the reference light rays at the beam splitter 21, and outputs, to the AD converter 32, electrical detection signals corresponding to the thus-received measurement light rays in a time-series manner. The AD converter 32 converts the thus-output electrical detection signals into digital signals, and outputs the thus-digitized detection signals to the multipliers 36.

In this state, each of the multipliers 36 calculates the product of the digital detection signal output from the AD converter 32 and the PN sequence supplied from the corresponding spread code sequence acquisition unit 35. Subsequently, the multiplier 36 outputs the thus-calculated product to the corresponding accumulator 37, and the accumulator 37 accumulates the thus-output product over one period (i.e., 128 bit length) or more of the PN sequence. Thus, through the processing for obtaining the sum of products performed by the multipliers 36 and the accumulators 37, the digital detection signals can be correlated with the above-supplied PN sequences, whereby only a detection signal corresponding to the near infrared low coherent light beam from the specific light generation unit 10; specifically, a detection signal corresponding to the measurement light ray having a wavelength of 830 nm or 780 nm, is selected and output.

As described above, two different PN sequences are orthogonal with each other; i.e., the product of the different PN sequences becomes “0.” Therefore, when, for example, a spread code sequence acquisition unit 35 supplies the PN sequence of the light emission section 1 to the corresponding multiplier 36, the product of the supplied PN sequence and a detection signal (among the detection signals output from the AD converter 32) other than the detection signal corresponding to the near infrared low coherent light beam output from the specific light generation unit 10 becomes “0.” Therefore, the value obtained through accumulation by the accumulator 37 over at least one period of the PN sequence becomes “0,” and the correlation becomes “0.” Thus, a detection signal which does not have the PN sequence supplied from the spread code sequence acquisition unit 35 (or a detection signal which does not match the PN sequence); i.e., the measurement light ray derived from the near infrared low coherent light beam output from a light generation unit other than the specific light generation unit 10 is selectively eliminated; and only the detection signal corresponding to the measurement light ray derived from the near infrared low coherent light beam output from the specific light generation unit 10 is output to the computation unit 33.

In the second embodiment as well, the movable mirror 22 is moved so as to gradually change the position of the reflection surface of the measurement light in the profile direction of the eyeground. Through this operation, as in the first embodiment, the computation unit 33 calculates the profile of the eyeground by use of the quantity distribution of the measurement light at the reflection surface, and outputs to the image-processing unit 34 a profile signal representing the calculated profile of the eyeground. Moreover, as in the first embodiment, through use of the selectively obtained detection signals corresponding to the near infrared low coherent light beams of 830 nm and 780 nm, the computation unit 33 calculates the oxygen saturation SO₂ in accordance with the above-described Eqs. 1 to 6, and outputs to the image-processing unit 34 an oxygen saturation signal representing the calculated oxygen saturation SO₂. Thus, as in the first embodiment, the display section 4 displays the profile of the eyeground and the oxygen saturation of the eyeground individually or in a composed or mixed manner.

As can be understood from the above description, the optical coherence tomograph S according to the second embodiment has advantageous effects similar to those attained in the first embodiment. Moreover, through simultaneous emission of two near infrared low coherent light beams having different wavelengths, change in oxygen saturation can be calculated more exactly. That is, although change in oxygen saturation with time is relatively slow, strictly speaking, it changes with time. In contrast, in the case where two near infrared low coherent light beams having different wavelengths are output simultaneously, measurement light rays which reflect the oxygen saturation at the same point in time reach the light detection section 3. Therefore, the oxygen saturation at the instantaneous time can be well calculated, and change in the oxygen saturation with elapse of time can be calculated quite accurately.

In the second embodiment, secondary drive signals are generated through spread spectrum modulation of primary drive signals; i.e., drive signals supplied from the controller 5, whereby two near infrared low coherent light beams are output without interfering with each other. However, the second embodiment may be modified so as to generate the secondary drive signals through FDMA (frequency division multiple access) modulation of the primary drive signals supplied from the controller 5 to prevent the interference between the two near infrared low coherent light beams. In this case, the spread code sequence generators 13 and the multipliers 14 of the light emission section 1 of the second embodiment are removed, and an FDMA modulator is provided. Moreover, in this case, the spread code sequence acquisition units 35, the multipliers 36, and the accumulators 37 of the light detection section 3 of the second embodiment are removed, and a demodulator is provided. Notably, operation of the FDMA modulator will not be described in detail, because modulation processing and demodulation processing can be performed by use of widely known conventional methods.

In the light emission section 1 of the optical coherence tomograph S configured as described above, the primary drive signals supplied from the controller 5 undergo the FDMA modulation performed by the FDMA modulator, whereby the secondary drive signals are generated. The two light sources 12 simultaneously emit two near infrared low coherent light beams on the basis of the generated secondary drive signals. In the light detection section 3, the demodulator demodulates the detection signal output from the AD converter 32, whereby only the detection signal corresponding to the measurement light ray derived from the near infrared low coherent light beam output from the specific light generation unit 10 is output to the computation unit 33. Accordingly, in this case as well, effects similar to those attained in the second embodiment are expected.

### c. Other Modifications

The present invention is not limited to the above-described embodiments, and various modifications are possible without departing from the scope of the present invention.

For example, in the above-described embodiments, oxygen saturation SO₂ is calculated in accordance with the above-described Eqs. 1 to 6 (more specifically, Eq. 6). As is apparent from Eqs. 4 and 5, the oxy-hemoglobin concentration change ΔCoxy and the deoxy-hemoglobin concentration change ΔCdeoxy calculated in the embodiments change depending on the optical path length d. In general, precise measurement or calculation of the optical path length d of light having entered the interior of a living organism is considerably difficult. Accordingly, the optical path length d in Eqs. 4 and 5 is a relative value, and oxygen saturation SO₂ calculated in accordance with Eq. 6 by use of the oxy-hemoglobin concentration change ΔCoxy and the deoxy-hemoglobin concentration change ΔCdeoxy is also a relative value.

In contrast, in the case where oxygen saturation SO₂ is calculated in accordance with the following equations, the oxygen saturation SO₂ in the pulsation component; i.e., the oxygen saturation SO₂ in the artery or arteriole, is calculated. Since this oxygen saturation calculation method is widely known as disclosed in, for example, Japanese Patent Application Laid-Open (kokai) No. S63-111837, its detailed description is omitted.

Extinction of infrared light within a living organism can be calculated by the following Eq. 7
−log(I1/I0)=E·C·e+A Eq. 7
In Eq. 7, I1 represents the quantity of transmitted light, and I0 represents the quantity of incident light. Further, E represents the light absorption coefficient of hemoglobin, C represents the concentration of hemoglobin in the blood, e represents the thickness of a blood layer (corresponding to the optical path length d in Eqs. 4 and 5), and A represents the light extinction of the tissue layer. Although Eq. 7 is adapted to calculate the extinction of infrared light having passed through the interior of a living organism, even reflected infrared light is known to exhibit similar characteristics.

If the thickness e of a blood layer changes by Δe due to pulsation, a change in infrared light extinction can be calculated in accordance with the following Eq. 8.
−(log(I1/I0)−log(I2/I0))=E·C·e−E·C·(e−Δe) Eq. 8
Eq. 8 can be simplified to the following Eq. 9
−log(I2/I1)=E·C·Δe Eq. 9
I2 in Eqs. 8 and 9 represents the quantity of transmitted light after the thickness of the blood layer has changed.

Next, there will be considered the case where an infrared light beam having a wavelength λ1 and an infrared light beam having a wavelength λ2 have passed the interior of a living organism with resultant generation of a first transmitted light beam (λ1) of quantity I1 and a second transmitted light beam (λ2) of quantity I2. When the quantity of the first transmitted light beam (λ1) as measured at times t1 and t2 is represented by I11 and I21, and the quantity of the second transmitted light beam (λ2) as measured at times t1 and t2 is represented by I12 and I22, the change in infrared light extinction at times t1 and t2 can be represented by the following Eqs. 10 and 11, which are based on Eq. 9.
−log(I21/I11)=E1·C·Δe Eq. 10
−log(I22/I12)=E2·C·Δe Eq. 11
E1 in Eq. 10 represents the light absorption coefficient of hemoglobin for the infrared light beam of λ1, and E2 in Eq. 11 represents the light absorption coefficient of hemoglobin for the infrared light beam of λ2. When the term Δe, which represents change in the thickness of the blood layer, is eliminated by dividing Eq. 11 by Eq. 10, the following Eq. 12 is obtained.
log(I12/I22)/log(I11/I21)=E2/E1 Eq. 12
Therefore, the following Eq. 13 is obtained through modification of Eq. 12.
E2=E1·log(I12/I22)/log(I11/I21) Eq. 13

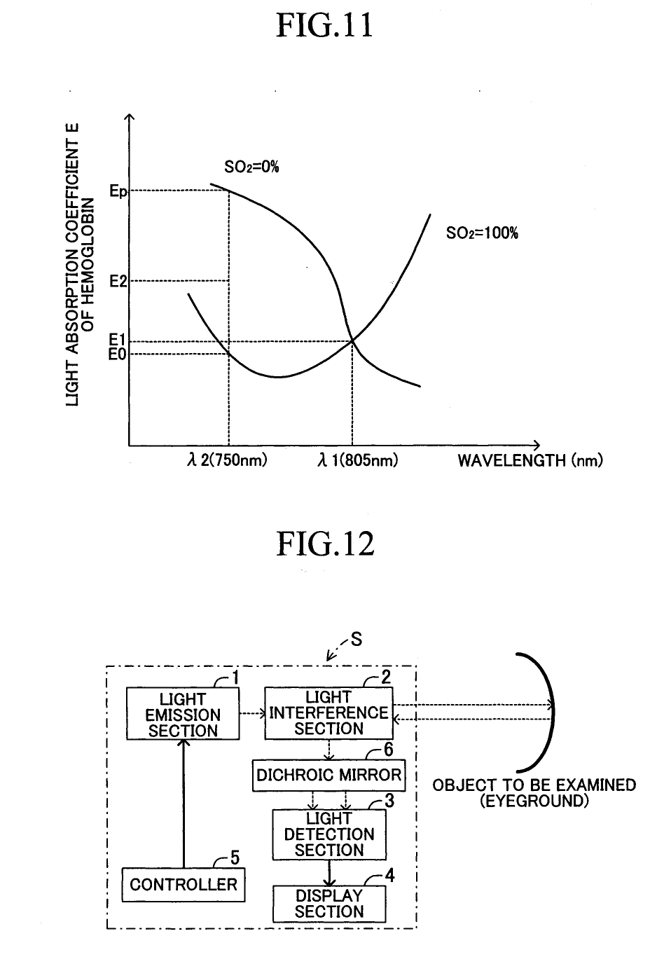

FIG. 11 shows change in light absorption spectrum of hemoglobin with oxygen saturation. Here, 805 nm is selected as a light absorption wavelength corresponding to the light absorption coefficient E1 of hemoglobin. Thus, the intersection between a curve for SO₂=0% and a curve for SO₂=100% is obtained. As a result, the light absorption coefficient E1 becomes a value which is not influenced by oxygen saturation. Further, for example, 750 nm is selected as a light absorption wavelength corresponding to the light absorption coefficient E2 of hemoglobin, the light absorption coefficient of hemoglobin at the time when oxygen saturation SO₂=0% is represented by Ep, and the light absorption coefficient of hemoglobin at the time when oxygen saturation SO₂=100% is represented by E0, the present oxygen saturation SO₂ can be calculated in accordance with the following Eq. 14.
SO₂=(E2−Ep)/(E0−Ep) Eq. 14
Since the oxygen saturation SO₂ calculated in accordance with Eq. 14 is calculated without use of any relative value, the actual oxygen saturation can be obtained. Accordingly, in diagnosis by a medical doctor, more accurate oxygen saturation SO₂ can be provided. Notably, since the thickness of the blood layer changes at considerably high speed, in this case, preferably, the light sources 12 of the light emission section 1 are simultaneously driven so as to simultaneously output near infrared low coherent light beams having different specific wavelengths, as described in relation to the second embodiment.

In the second embodiment and its modification, the light emission section 1 is configured to drive the light sources 12 on the basis of the secondary drive signals obtained through modulation of the primary drive signals supplied from the controller 5, to thereby output near infrared low coherent light beams. The light detection section 3 is configured to separate a detection signal through demodulation of the secondary drive signals contained in interference light to the primary drive signals. However, two near infrared low coherent light beams having different specific wavelengths can be output without modulating the drive signals supplied from the controller 5. Next, this modification will be described specifically.

In this modification, the optical coherence tomograph S is configured as shown in FIG. 12. That is, a dichroic mirror 6 is provided between the light interference section 2 and the light detection section 3 to be located on the optical axis of interference light emitted from the light interference section 2. The dichroic mirror 6 optically separates near infrared low coherent light beams entering the same. Along with this, the light detection section 3 of this modification includes two light-receiving units 31.

Next, operation of the optical coherence tomograph S of this modification will be described. In the light emission section 1, the two light sources 12 simultaneously output a near infrared low coherent light beam of 830 nm and a near infrared low coherent light beam of 780 nm on the basis of predetermined drive signals supplied from the controller 5. The two emitted near infrared low coherent light beams are optically mixed by means of the optical fiber H and output to the light interference section 2. As in the second embodiment, the light interference section 2 outputs toward the light detection section 3 interference light produced as a result of interference between the measurement light and the reference light. At this time, since the dichroic mirror 6 is provided on the optical axis of the output interference light, the interference light having reached the mirror 6 is optically divided into two light rays. That is, the dichroic mirror 6 divides the interference light into an interference light ray having a wavelength of 830 nm and an interference light ray having a wavelength of 780 nm, which reach the two light-receiving units 31 provided in the light detection section 3.

The interference light rays having reached the light-receiving units 31 are supplied, as detection signals, to the AD converter 32, as in the second embodiment. The AD converter 32 supplies the corresponding digital detection signals to the computation unit 33, whereby, as in the second embodiment, profile and oxygen saturation SO₂ are calculated. Therefore, effects similar to those attained in the second embodiment are expected. Moreover, since a modulation unit and a demodulation unit are not required, the structure of the optical coherence tomograph S can be simplified.

In the above-described embodiments and modifications, oxygen saturation SO₂ (biological information) is calculated by use of the quantity of near infrared low coherent light output from the light emission section 1 and the quantity of interference light detected by the light detection section 3. However, other types of biological information, such as blood flow within the blood vessel and change in blood flow, can be calculated and displayed at the display section 4, so long as these can be calculated by use of the quantity of near infrared low coherent light output from the light emission section 1 and the quantity of interference light detected by the light detection section 3. Further, in the above-described embodiments and modifications, the optical coherence tomograph S is applied to the examination of the eyeground. However, the optical coherence tomograph S can be used for examination of other parts of living organisms.

In the first embodiment, the light sources 12 of the light emission section 1 successively generate light beams with a predetermined short time interval therebetween, on the basis of the drive signals supplied from the controller 5. Even in such a case where the light sources 12 are driven to successively generate light beams, needless to say, it is possible to generate secondary drive signals by modulating the drive signals supplied from the controller 5 (primary drive signals) and drive the light sources 12 so as to generate light beams on the basis of the secondary drive signals, as has been described in relation to the second embodiment and modifications.

What is claimed is:

1. An optical coherence tomograph comprising:
a controller operable by a user and outputting various signals on the basis of instructions from the user;
a light emission section including a plurality of light sources emitting light on the basis of predetermined drive signals supplied from the controller and adapted to emit near infrared low coherent light beams having different specific wavelengths;
a light interference section including separation means for allowing the near infrared low coherent light beams emitted from the light emission section to pass therethrough toward an object to be examined and for partially reflecting and separating the near infrared low coherent light beams, reflection means for reflecting the separated near infrared low coherent light beams toward the separation means, moving means for moving the reflection means along the optical axis of the near infrared low coherent light beams separated by means of reflection, and interfering means provided integrally with the separation means and adapted to cause optical interference between the near infrared low coherent light beams reflected by the reflection means and the near infrared low coherent light beams reflected by the object to be examined;
a light detection section including light-receiving means for receiving interference light rays produced as a result of the optical interference at the light interference section, profile information calculation means for calculating profile information representing the profile of the object on the basis of the light quantities of the interference light rays received by the light-receiving means, biological information calculation means for calculating biological information of the object associated with metabolism of living organism on the basis of the light quantities of the near infrared low coherent light beams emitted from the light emission section and the light quantities of the interference light rays received by the light-receiving means, and image data generation means for generating visible image data on the basis of the profile information calculated by the profile information calculation means and the biological information calculated by the biological information calculation means; and
a display section for displaying, on the basis of the image data generated by the light detection section, a profile image of the object, a biological information image of the object, or a composite image obtained through composition of the profile image and the biological information image.

2. An optical coherence tomograph according to claim 1, wherein
the light emission section further includes spread spectrum modulation means for modulating predetermined primary drive signals supplied from the controller by spread spectrum modulation to thereby generate secondary drive signals, and light-mixing means for optically mixing the near infrared low coherent light beams having different specific wavelengths simultaneously emitted from the light sources driven simultaneously on the basis of the secondary drive signals; and
the light detection section further includes demodulation means for despreading and demodulating the secondary drive signals contained in the interference light rays received by the light-receiving means to thereby obtain the predetermined primary drive signals.

3. An optical coherence tomograph according to claim 1, wherein
the light emission section further includes frequency-division-multiple-access-modulation means for modulating predetermined primary drive signals supplied from the controller by means of frequency division multiple-access modulation to thereby generate secondary drive signals, and light-mixing means for optically mixing the near infrared low coherent light beams having different specific wavelengths simultaneously emitted from the light sources driven simultaneously on the basis of the secondary drive signals; and
the light detection section further includes demodulation means for demodulating the secondary drive signals contained in the interference light rays received by the light-receiving means to thereby obtain the predetermined primary drive signals.

4. An optical coherence tomograph according to claim 1, wherein the light emission section acquires predetermined drive signals supplied from the controller with a predetermined time interval therebetween, and the light sources are successively driven on the basis of the acquired predetermined drive signals so as to successively emit near infrared low coherent light beams having different specific wavelengths with the predetermined time interval therebetween.

5. An optical coherence tomograph according to claim 4, wherein
the light emission section further includes spread spectrum modulation means for modulating, by spread spectrum modulation, predetermined drive signals supplied from the controller with the predetermined time interval therebetween to thereby generate modulated drive signals, whereby the light sources are successively driven by the modulated drive signals so as to successively emit near infrared low coherent light beams having different specific wavelengths with the predetermined time interval therebetween; and
the light detection section further includes demodulation means for demodulating the modulated drive signals contained in the interference light rays received by the light receiving means to thereby obtain the predetermined drive signals.

6. An optical coherence tomograph according to claim 4, wherein
the light emission section further includes modulation means for modulating, by means of frequency division multiple-access modulation, predetermined drive signals supplied from the controller with the predetermined time interval therebetween to thereby generate modulated drive signals, whereby the light sources are successively driven by the modulated drive signals so as to successively emit near infrared low coherent light beams having different specific wavelengths with the predetermined time interval therebetween; and
the light detection section further includes demodulation means for demodulating the modulated drive signals contained in the interference light rays received by the light receiving means to thereby obtain the predetermined drive signals.

7. An optical coherence tomograph according to claim 1, wherein a light separation section for optically separating interference light rays produced as a result of optical interference at the light interference section is provided between the light interference section and the light detection section, and the light detection section includes a plurality of right-receiving means for receiving the interference light rays separated by the light separation section.

8. An optical coherence tomograph according to claim 1, wherein the display section displays a composite image obtained by mixing the profile image and the biological information image such that a position specified by the profile image of the object and a position specified by the biological information image of the object coincide with each other.

9. An optical coherence tomograph according to claim 1, wherein the biological information calculated by the biological information calculation means of the light detection section is one selected from the group consisting of blood volume, blood flow rate, change in blood flow, and oxygen saturation within a blood vessel of the object.

10. An optical coherence tomograph according to claim 1, wherein the object is the eyeground of the eyeball.
